(19) United States
(12) Patent Application Publication
(10) Pub. No.: US 2024/0046786 A1
(43) Pub. Date: Feb. 8, 2024

(54) INFORMATION PROCESSING APPARATUS, INFORMATION PROCESSING METHOD, AND COMPUTER PROGRAM

(71) Applicant: Sumitomo Electric Industries, Ltd., Osaka-shi, Osaka (JP)

(72) Inventors: Yasushi NAGASHIMA, Osaka-shi, Osaka (JP); Hiroshi MATSUMOTO, Osaka-shi, Osaka (JP); Toshiya YOSHIOKA, Osaka-shi, Osaka (JP); Shintaro MATSUMOTO, Osaka-shi, Osaka (JP)

(73) Assignee: Sumitomo Electric Industries, Ltd., Osaka-shi, Osaka (JP)

(21) Appl. No.: 18/265,678

(22) PCT Filed: Aug. 26, 2021
(86) PCT No.: PCT/JP2021/031387

§ 371 Date: Jun. 7, 2023

(30) Foreign Application Priority Data
Dec. 11, 2020 (JP) 2020-205958

(51) Int. Cl. G08G 1/07; G08G 1/01

(52) U.S. Cl. CPC G08G 1/07; G08G 1/0112

(57) ABSTRACT

Provided is an information processing apparatus including: an operation unit configured to receive an operation input regarding a first extraction condition; and a control unit configured to perform predetermined information processing, based on the first extraction condition. The information processing includes: a process of extracting one or a plurality of intersection nodes corresponding to intersections that conform to the first extraction condition, from among nodes included in map data; a process of acquiring time-series data of traffic information from a database in which the time-series data of the traffic information is accumulated; and a process of selecting, from among the one or the plurality of intersection nodes having been extracted, a target intersection that requires adjustment of a constant of a traffic signal controller, based on the acquired time-series data of the traffic information, and outputting the selected target intersection to a display unit.

### TECHNICAL FIELD

The present disclosure relates to an information processing apparatus, an information processing method, and a computer program.

This application claims priority on Japanese Patent Application No. 2020-205958 filed on Dec. 11, 2020, the entire content of which is incorporated herein by reference.

### BACKGROUND ART

NON-PATENT LITERATURE 1 discloses that schemes for traffic signal control can be classified into: a centralized control scheme (remote control) in which a central apparatus in a traffic control center collectively controls traffic signal controllers at a plurality of intersections; and an independent control scheme (point control) in which a traffic signal controller independently operates.

In the remote control, the central apparatus generates a signal control instruction including a signal control parameter in each predetermined control cycle, and transmits the generated signal control instruction to the traffic signal controllers through dedicated lines.

PATENT LITERATURE 1 discloses a traffic signal control system adopting the centralized control scheme, in which a central apparatus in a traffic control center determines congestion states of roads that lead to an intersection, based on probe information including positions and times of vehicles, and adjusts signal control parameters of traffic signal controllers so as to ease the traffic congestion, based on the determination result.

### CITATION LIST

### Patent Literature

PATENT LITERATURE 1: Japanese Laid-Open Patent Publication No. 2009-146138

### Non Patent Literature

NON PATENT LITERATURE 1: “Manual on Traffic Signal Control, Revised Edition”, Japan Society of Traffic Engineers, July 2006, pp. 96 to 98

### SUMMARY OF THE INVENTION

An apparatus according to one aspect of the present disclosure is an information processing apparatus including: an operation unit configured to receive an operation input regarding a first extraction condition; and a control unit configured to perform predetermined information processing, based on the first extraction condition. The information processing includes: a process of extracting one or a plurality of intersection nodes corresponding to intersections that conform to the first extraction condition, from among nodes included in map data; a process of acquiring time-series data of traffic information from a database in which the time-series data of the traffic information is accumulated; and a process of selecting, from among the one or the plurality of intersection nodes having been extracted, a target intersection that requires adjustment of a constant of a traffic signal controller, based on the acquired time-series data of the traffic information, and outputting the selected target intersection to a display unit.

A method according to one aspect of the present disclosure is an information processing method performed by an information processing apparatus including: an operation unit configured to receive an operation input regarding a first extraction condition; and a control unit configured to perform predetermined information processing, based on the first extraction condition. The method includes the steps of: extracting one or a plurality of intersection nodes corresponding to intersections that conform to the first extraction condition, from among nodes included in map data; acquiring time-series data of traffic information from a database in which the time-series data of the traffic information is accumulated; and selecting, from among the one or the plurality of intersection nodes having been extracted, a target intersection that requires adjustment of a constant of a traffic signal controller, based on the acquired time-series data of the traffic information, and outputting the selected target intersection to a display unit.

A computer program according to one aspect of the present disclosure is a computer program configured to cause a computer to function as an information processing apparatus including: an operation unit configured to receive an operation input regarding a first extraction condition; and a control unit configured to perform predetermined information processing, based on the first extraction condition. The information processing includes: a process of extracting one or a plurality of intersection nodes corresponding to intersections that conform to the first extraction condition, from among nodes included in map data; a process of acquiring time-series data of traffic information from a database in which the time-series data of the traffic information is accumulated; and a process of selecting, from among the one or the plurality of intersection nodes having been extracted, a target intersection that requires adjustment of a constant of a traffic signal controller, based on the acquired time-series data of the traffic information, and outputting the selected target intersection to a display unit.

The present disclosure can be realized not only as a system and an apparatus having the characteristic configurations as described above, but also as a program for causing a computer to perform such characteristic configurations. In addition, the present disclosure can be realized as a semiconductor integrated circuit that realizes a part or all of the system and the apparatus.

### BRIEF DESCRIPTION OF DRAWINGS

FIG. 1 is a schematic configuration diagram showing an information processing apparatus according to an embodiment of the present disclosure.

FIG. 2A illustrates an example of a designated area input screen.

FIG. 2A illustrates another example of a designated area input screen.

FIG. 3 illustrates an example of time-series data of traffic information.

FIG. 4 is a flowchart showing an example of details of information processing.

FIG. 5 is a flowchart showing an example of intersection detection.

FIG. 6A illustrates an example of a node determined to be an intersection.

FIG. 6B illustrates an example of a node determined not to be an intersection.

FIG. 7 is a flowchart showing an example of inflow road detection.

FIG. 8 illustrates an example of a most upstream link detected by inflow road detection.

FIG. 9 illustrates an example of one-side congestion detected by a control unit.

FIG. 10 illustrates an example of representation of target intersections.

FIG. 11 illustrates another example of representation of target intersections.

FIG. 12 illustrates an example of representation of time-series transitions of congestion lengths.

FIG. 13 illustrates an example of representation of time-series transitions of inflow road speeds.

### DETAILED DESCRIPTION

<Problems to be Solved by the Present Disclosure>

Using the probe information enables determination of the congestion state of a road where no vehicle detector is installed. Therefore, even for a traffic signal controller adopting the independent control scheme, adjustment of a constant such as a green interval can be performed based on the determination result of the congestion state.

However, in order to adjust the traffic signal controller adopting the independent control scheme, an operator needs to visit the site and manually operate the controller. Therefore, a technology for perceiving in advance which is a target intersection that requires adjustment of a constant of a traffic signal controller, is desired. However, such a technology has not yet been developed.

An object of the present disclosure is to enable a user to perceive in advance a target intersection that requires adjustment of a constant of a traffic signal controller.

<Effects of the Present Disclosure>

According to the present disclosure, the user can perceive in advance a target intersection that requires adjustment of a constant of a traffic signal controller.

### Outline of Embodiment of the Present Disclosure

Hereinafter, the outline of an embodiment of the present disclosure is listed and described.

(1) An information processing apparatus according to the present embodiment includes an operation unit configured to receive an operation input regarding a first extraction condition, and a control unit configured to perform predetermined information processing, based on the first extraction condition. The information processing includes: a process of extracting one or a plurality of intersection nodes corresponding to intersections that conform to the first extraction condition, from among nodes included in map data; a process of acquiring time-series data of traffic information from a database in which the time-series data of the traffic information is accumulated; and a process of selecting, from among the one or the plurality of intersection nodes having been extracted, a target intersection that requires adjustment of a constant of a traffic signal controller, based on the acquired time-series data of the traffic information, and outputting the selected target intersection to a display unit.

According to the information processing apparatus of the present embodiment, the control unit selects, from among the extracted intersection nodes, a target intersection that requires adjustment of a constant of a traffic signal controller, based on the acquired time-series data of the traffic information, and causes the display unit to output the selected target intersection.

Therefore, the user can perceive in advance which intersection is a target intersection, based on the target intersection displayed on the display unit. Thus, the user can easily judge whether or not a target intersection is present.

(2) In the information processing apparatus according to the present embodiment, the first extraction condition may include a designated area that is a geographical range designated by a user, and the control unit may extract nodes included in the designated area, in the process of extracting the intersection nodes.

In this case, intersection nodes to be extracted are narrowed to the nodes included in the designated area. Therefore, only a target intersection included in the designated area desired by the user can be outputted to the display unit.

(3) In the information processing apparatus according to the present embodiment, the first extraction condition may include a designated placement number that is a placement number designated by the user, and the control unit may extract nodes included in the designated area, in the process of extracting the intersection nodes.

In this case, intersection nodes to be extracted are narrowed to the nodes at which the number of placed signal light marks in the map data is equal to or less than the designated placement number. Therefore, only a target intersection of the scale desired by the user can be outputted to the display unit.

(4) In the information processing apparatus according to the present embodiment, the first extraction condition may include a designated class that indicates a road scale designated by the user, and the control unit may extract nodes at which the number of placed signal light marks in the map data is equal to or less than the designated placement number, in the process of extracting the intersection nodes.

In this case, intersection nodes to be extracted are narrowed to nodes connected to links whose road classes in the map data are equal to the designated class. Therefore, only a target intersection of the scale desired by the user can be outputted to the display unit.

(5) In the information processing apparatus according to the present embodiment, the operation unit may further receive an operation input regarding a second extraction condition, and the process of acquiring the time-series data of the traffic information in the information processing may be a process of acquiring time-series data of traffic information that conforms to the second extraction condition.

In this case, the control unit is allowed to select a target intersection, based on the time-series data of the traffic information that conforms to the second extraction condition desired by the user.

(6) In the information processing apparatus according to the present embodiment, the second extraction condition may include a designated period that is a temporal range designated by the user, and the control unit may acquire, from the database, the time-series data of the traffic information corresponding to the designated period.

In this case, time-series data of traffic information to be acquired from the database is narrowed to the time-series data corresponding to the designated period. This configuration allows the control unit to select a target intersection, based on the time-series data of the traffic information corresponding to the designated period desired by the user.

(7) In the information processing apparatus according to the present embodiment, when selecting the target intersection with presence/absence of one-side congestion being a selection criterion, the control unit outputs, to the display unit, the number of occurrences of one-side congestion at the selected target intersection.

In this case, the user can perceive in advance the degree of seriousness of the one-side congestion at the target intersection, based on the number of occurrences of one-side congestion displayed on the display unit. Therefore, the user can easily judge which target intersection should be firstly subjected to adjustment of a constant.

(8) In the information processing apparatus according to the present embodiment, the operation unit may further receive an event type that suggests a disorder in setting a constant of the traffic signal controller, and the control unit may use presence/absence of the event having been inputted, as a selection criterion for the target intersection.

In this case, the control unit is allowed to select a target intersection with presence/absence of the event desired by the user being a selection criterion.

(9) In the information processing apparatus according to the present embodiment, the event type may include at least one of one-side congestion, downstream congestion, and stop through several changes of signal light.

The reason is as follows. That is, each of one-side congestion, downstream congestion, and stop through several changes of signal light is an event that suggests a disorder in setting a constant (e.g., the number of seconds of a green interval) of a traffic signal controller. Therefore, presence/absence of such an event is appropriate as a criterion for selecting a target intersection.

(10) In the information processing apparatus according to the present embodiment, the control unit may be capable of analyzing a time-series transition of a predetermined traffic index on an inflow road of the intersection node, and may output, to the display unit, an analysis result of the time-series transition, with respect to an inflow road of an intersection designated by an operation input to a screen of the display unit.

In this case, the user can consider in which time section the target intersection should be subjected to adjustment of a constant, based on the time-series transition of the traffic index (e.g., congestion length or vehicle speed) displayed on the display unit.

(11) In the information processing apparatus according to the present embodiment, the time-series data of the traffic information may be generated based on probe information including position and time of a vehicle.

The reason is as follows. That is, the probe information includes the position and the time of a vehicle when the vehicle travels on a road where no vehicle detector is installed, and therefore, it is possible to generate time-series data of traffic information over a wide range.

(12) An information processing method according to the present embodiment is a method to be performed by the information processing apparatus according to the above (1) to (11).

Therefore, the information processing method according to the present embodiment exhibits the same operation and effect as those of the information processing apparatus according to the above (1) to (11).

(13) A computer program according to the present embodiment is a program that causes a computer to function as the information processing apparatus according to any of the above (1) to (11).

Therefore, the computer program according to the present embodiment exhibits the same operation and effect as those of the information processing apparatus according to the above (1) to (11).

### Details of Embodiment of the Present Disclosure

Hereinafter, the details of an embodiment of the present disclosure will be described with reference to the drawings. At least parts of the embodiment described below may be combined as desired.

### Configuration Example of Information Processing Apparatus

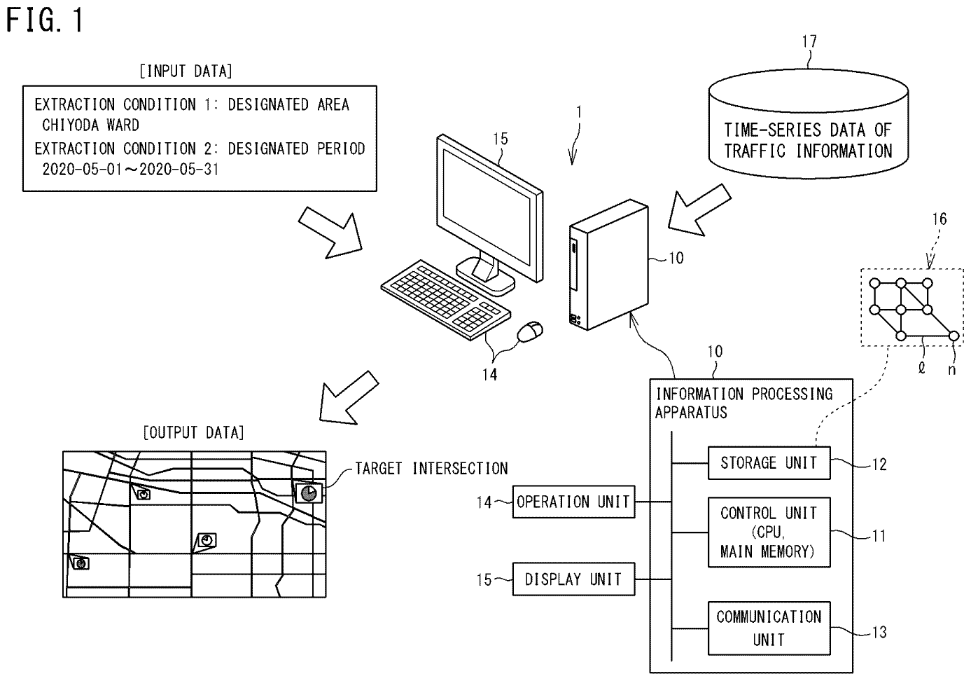

FIG. 1 is a schematic configuration diagram showing an information processing apparatus 1 according to the present embodiment.

As shown in FIG. 1, the information processing apparatus 1 is implemented by a personal computer (PC), for example, and includes a casing 10, and electronic devices housed in the casing 10. The electronic devices include a control unit (information processing unit) 11, a storage unit 12, a communication unit 13, and the like. An operation unit 14 and a display unit 15 are connected to the casing 10 of the information processing apparatus 1.

The control unit 11 is mounted on a motherboard in the casing 10, and the storage unit 12 and the communication unit 13 are attached to dedicated connectors disposed on the motherboard.

The operation unit 14 and the display unit 15 are respectively connected to predetermined connection ports disposed on the casing 10, and exchange predetermined information with the control unit 11 via a backplane or a bus. The control unit 11 controls the operations of the hardware parts 12 to 15.

The control unit 11 is implemented by an arithmetic processing device including a CPU (Central Processing Unit) and a main memory. The main memory of the control unit 11 is a RAM (Random Access Memory) which is a volatile memory.

The CPU of the control unit 11 reads out, into the main memory, a computer program (software) installed in the storage unit 12, and performs various kinds of information processing according to the read computer program.

The storage unit 12 is an auxiliary storage device that includes at least one of: a storage medium that is at least one of an HDD (Hard Disk Drive) and an SSD (Solid State Drive) which are non-volatile memories; and an external or built-in optical drive.

The communication unit 13 is a communication card (e.g., LAN card) that performs Ethernet (registered trademark) communication with external devices. The communication unit 13 is connected to a gateway leading to the Internet, by a predetermined communication cable such as a LAN cable, or a wireless LAN.

The operation unit 14 is an input device including a keyboard and a pointing device such as a mouse. The operation unit 14 may include a touch panel type device that allows the user to perform an operation input by touching a screen of the display unit 15 with a finger or a pen.

The user such as a traffic engineer can transmit a predetermined instruction to the control unit 11 by performing an operation input such as keyboard input, mouse click, or touch operation.

The display unit 15 is a display device such as a liquid crystal monitor or an organic EL (Electro Luminescence) panel. For example, the display unit 15 can display a GUI (Graphical User Interface) screen for receiving an operation input through the operation unit 14, a GUI screen having a map inside, and the like.

In the storage unit 12, map data 16 covering a predetermined area on the earth (e.g., the whole of Japan or the whole world) is stored. The map data 16 may be stored in a cloud server that performs a data providing service regarding the map.

In this case, the control unit 11 downloads the map data 16 within a predetermined range by communicating with the cloud server via the communication unit 13, temporarily stores the acquired map data 16 within the predetermined range into the storage unit 12, and causes the display unit 15 to display the map data 16.

The map data 16 is composed of a plurality of layers of data, in which a layer of background data and a layer of road data are overlapped one over another. The background data includes data of rivers, coastlines, administrative boundaries, railway lines, facilities such as a station and an airport, signal light marks according to the scales of intersections, and the like.

Two or more signal light marks are often disposed at a relatively large-scale intersection adopting the centralized control scheme, while only one or no signal light mark is often disposed at a relatively small-scale intersection adopting the independent control scheme.

Therefore, a node n having two or more signal light marks can be estimated as an intersection adopting the centralized control scheme. Meanwhile, a node n having one or less signal light mark can be estimated to be an intersection adopting the independent control scheme.

The road data is data indicating an actual road alignment by a directed graph that is composed of nodes n and directed links 1 (lowercase “L”).

Specifically, the road data in the map data 16 is a directed graph obtained by connecting, with directed links 1, a plurality of nodes n corresponding to intersections, junctions, etc., in an actual road network. Therefore, a one-way road is indicated by only a one-way link 1.

Data given to each node n includes a node ID. The node ID is an identification number that is given in advance to an intersection, a junction, or the like. The data given to each node n also includes position information (latitude, longitude, and altitude) of the node.

In the case where two or more roads intersect, such as crossroads, a T-junction, etc., an “intersection” refers to an area where the two or more roads (roadways when each road includes a roadway and a sidewalk) intersect (Road Traffic Act, Article 2, Paragraph 1, Item. 5). In addition, a “junction” refers to a point where two traffic flows meet to become one traffic flow.

Generally, it is often the case that traffic signal controllers are installed at intersections, and are not installed at junctions.

Data given to each link 1 includes a link ID that is an identification number of the link 1, and pieces of information 1) to 4) as follows, associated with the link ID.
1) Position information (latitude, longitude, and altitude) of start/end/interpolation points of the link
2) Link ID that connects to the start point of the link
3) Link ID that connects to the end point of the link
4) Link cost of the link

Each link 1 in the map data 16 also includes road class information indicating the scale of the corresponding road (basic road such as national road or prefectural road, narrow road, etc.).

Furthermore, the map data 16 also includes: road type information indicating whether a specific link 1 indicating a road is an ordinary road or a toll road; in-link information indicating whether or not a bridge, a tunnel, a tollgate, etc., is included in the link 1; and the like.

A traffic information database 17 has, stored therein, time-series data obtained by arranging, for each predetermined time, traffic information such as a link average speed or a link travel time in the past.

The traffic information database 17 is stored in, for example, a cloud server (hereinafter referred to as “traffic information server”) that performs a data providing service regarding the traffic information. The traffic information server generates time-series data of traffic information from probe information including positions and times of vehicles, and stores the generated time-series data into the database 17.

[Outline of information processing by information processing apparatus]

As shown in FIG. 1, input data that the user inputs to the information processing apparatus 1 through the operation unit 14, includes a node extraction condition (hereinafter also referred to as “extraction condition 1”), and a time-series data extraction condition (hereinafter also referred to as “extraction condition 2”).

The node extraction condition (extraction condition 1) includes a geographical range designated by the user (hereinafter referred to as “designated area”). The time-series data extraction condition (extraction condition 2) includes a temporal range designated by the user (hereinafter referred to as “designated period”).

In the example shown in FIG. 1, “Chiyoda Ward” is illustrated as the designated area, and one month corresponding to “2020-05-01 to 2020-05-31” is illustrated as the designated period.

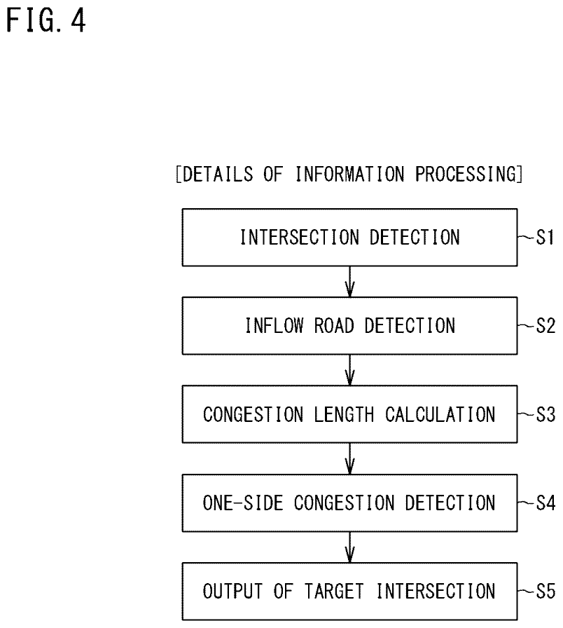

The control unit 11 performs intersection detection (step S1 in FIG. 4) described later, for a plurality of nodes that conform to the extraction condition 1 (a plurality of nodes included in the designated area) among the nodes included in the map data 16, and extracts, from the map data 16, a plurality of nodes corresponding to intersections (hereinafter referred to as “intersection nodes”).

As for links that flow in the extracted intersection nodes, the control unit 11 acquires, from the database 17 in the traffic information server, time-series data of traffic information that conforms to the extraction condition 2 (time-series data of traffic information included in the designated period).

That is, the control unit 11 performs inflow road detection described later (step SS2 in FIG. 4) for each intersection node, and acquires, from the database 17, time-series data of traffic information corresponding to the designated period, with respect to a plurality of links extracted as inflow roads.

Specifically, the control unit 11 transmits, to the traffic information server, link IDs of the inflow roads extracted by the inflow road detection, and the period designated by the user. The traffic information server extracts, from the database 17, the time-series data of the traffic information related to the received link IDs and corresponding to the designated period, and transmits the extracted time-series data to the information processing apparatus 1.

The information processing apparatus 1 may also serve as the traffic information server. In this case, the database 17 is stored in the storage unit 12 of the information processing apparatus 1.

Based on the acquired time-series data of the traffic information, the control unit 11 selects an intersection (hereinafter referred to as “target intersection”) that is estimated to require adjustment of a constant (e.g., adjustment of a green interval) of the traffic signal controller, from among the plurality of intersection nodes having been extracted.

The control unit 11 causes the display unit 15 to display the selected target intersection so that the user can recognize the position of the target intersection.

As an example of a traffic event to be a selection criterion for an intersection that requires adjustment of a constant of a traffic signal controller, “one-side congestion” is adopted in the present embodiment. The “one-side congestion” refers to a traffic congestion on a single inflow road, or traffic congestions on a plurality of inflow roads that are processed in the same phase.

Therefore, based on the acquired time-series data of the traffic information, the control unit 11 of the information processing apparatus 1 selects, as a target intersection, an intersection node where one-side congestion is assumed to be occurring, from among the plurality of intersection nodes.

[Input Screen for Designated Area]

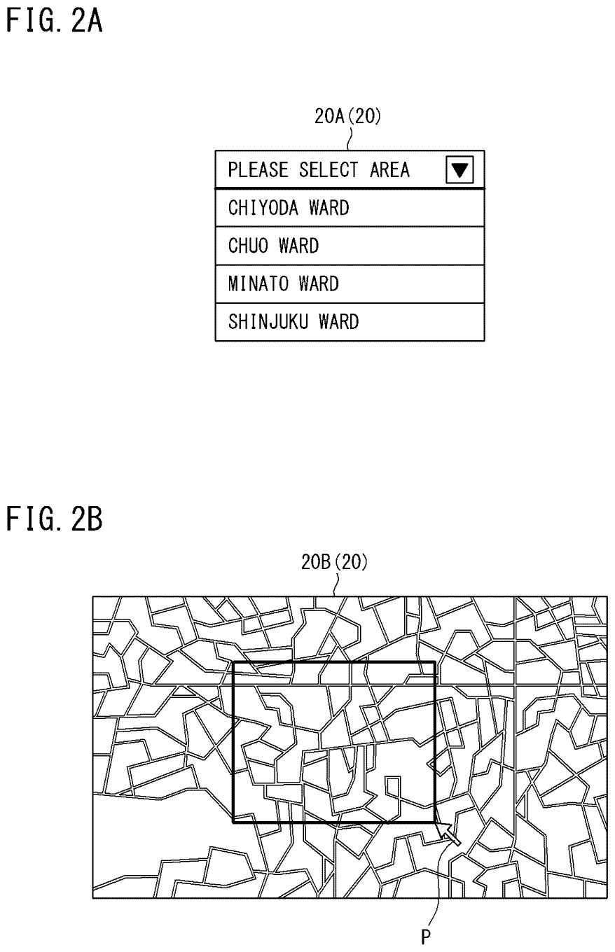

FIG. 2A and FIG. 2B each illustrate an example of a designated area input screen 20.

As shown in FIG. 2A, the designated area input screen 20 is, for example, an input box 20A that allows the user to select (designate) an area from a pull-down menu.

In this case, the control unit 11 of the information processing apparatus 1 extracts, from the map data 16, a plurality of nodes included in the area selected (designated) from the menu of the input box 20A by the user, and uses the extracted nodes as target nodes to be subjected to intersection detection.

As shown in FIG. 2B, the designated area input screen 20 may be a GUI screen 20B that allows the user to directly designate an area with a mouse pointer P or the like on a map displayed on the screen, for example.

In this case, the control unit 11 of the information processing apparatus 1 extracts, from the map data 16, nodes included in a selected area designated by the mouse pointer P, and uses data regarding the extracted nodes as target nodes to be subjected to intersection detection.

[Time-Series Data of Traffic Information]

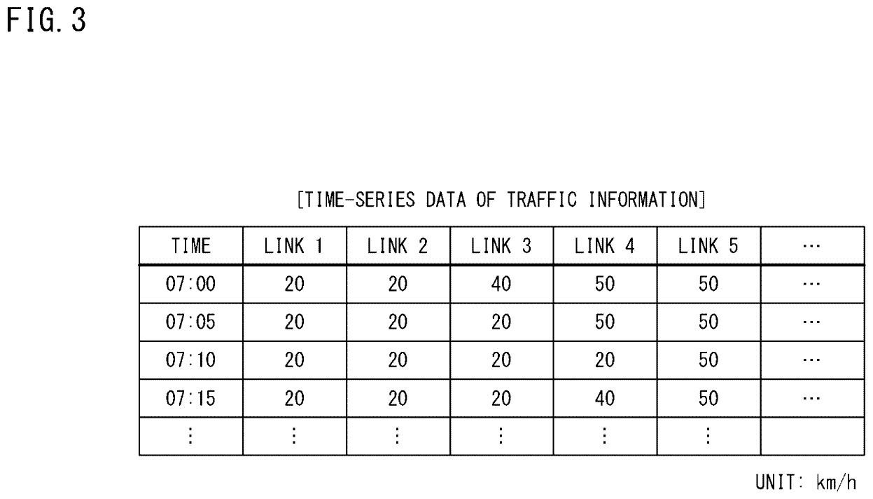

FIG. 3 illustrates an example of time-series data of traffic information.

As shown in FIG. 3, the time-series data of the traffic information accumulated in the database 17 is data in a table format including columns of “time”, “link 1”, “link 2”, “link 3”, “link 4”, and “link 5”, for example.

Under the column of “time”, time values are entered at each predetermined time interval (e.g., 5 minutes) in chronological order. The length of the predetermined time interval may be changed in accordance with time sections. While FIG. 3 shows the time-series data for one day, the time-series data may be divided into data per day of the week, for example.

Under the column of “link 1”, values of traffic information (in FIG. 3, link average speed) in the link 1 corresponding to the time values, are entered. Under the column of “link 2”, values of traffic information in the link 2 corresponding to the time values are entered. The same applies to the links 3 to 5.

Although five links 1 to 5 are illustrated in FIG. 3, the number of links included in the time-series data of the traffic information is not limited to five. Moreover, although the traffic information is the link average speed (km/h) in FIG. 3, the traffic information may be the link travel time (sec).

[Details of Processing by Information Processing Apparatus]

FIG. 4 is a flowchart showing an example of details of information processing performed by the control unit 11 of the information processing apparatus 1.

As shown in FIG. 4, the information processing performed by the control unit 11 includes “intersection detection” (step S1), “inflow road detection” (step S2), “congestion length calculation” (step S3), “one-side congestion detection” (step S4), and “output of target intersection” (step S5).

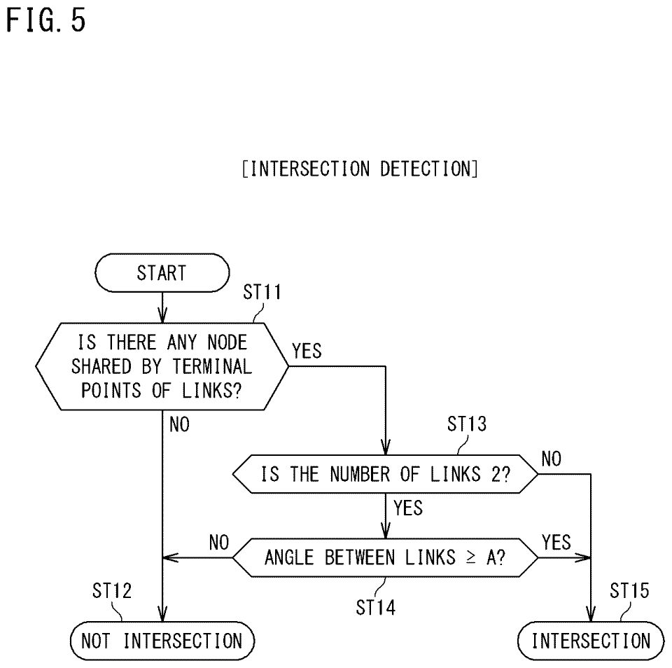

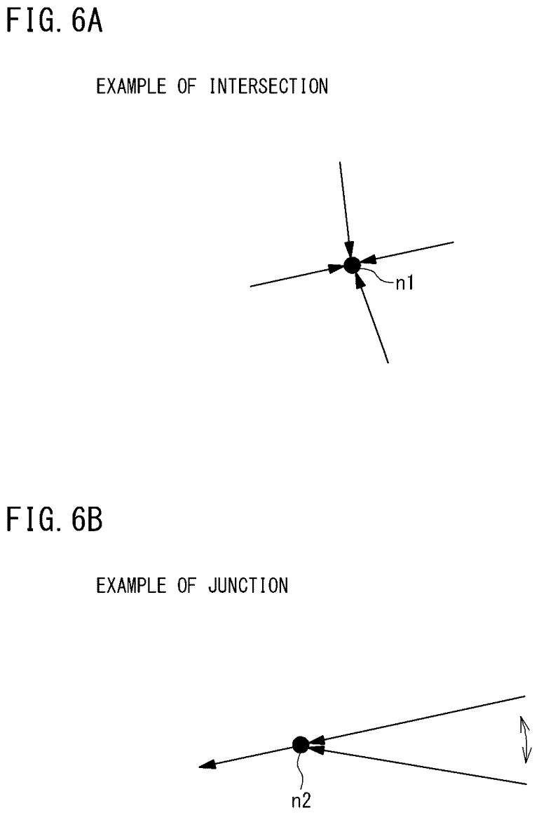

The intersection detection (step S4) is a process of extracting intersection nodes from among a plurality of nodes included in a designated area. In other words, it is a process of excluding nodes corresponding to junctions. The intersection detection will be described in detail later (FIG. 5, FIG. 6A, and FIG. 6B).

However, in the case of the map data 16 in which identification information indicating an intersection is given to a node, intersection detection may be a process of collecting nodes having identification information indicating intersections from an area designated by the user.

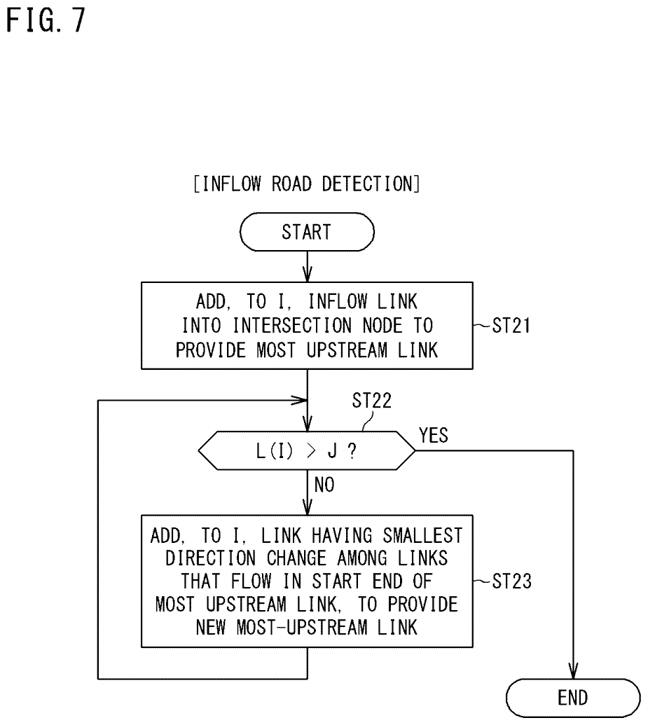

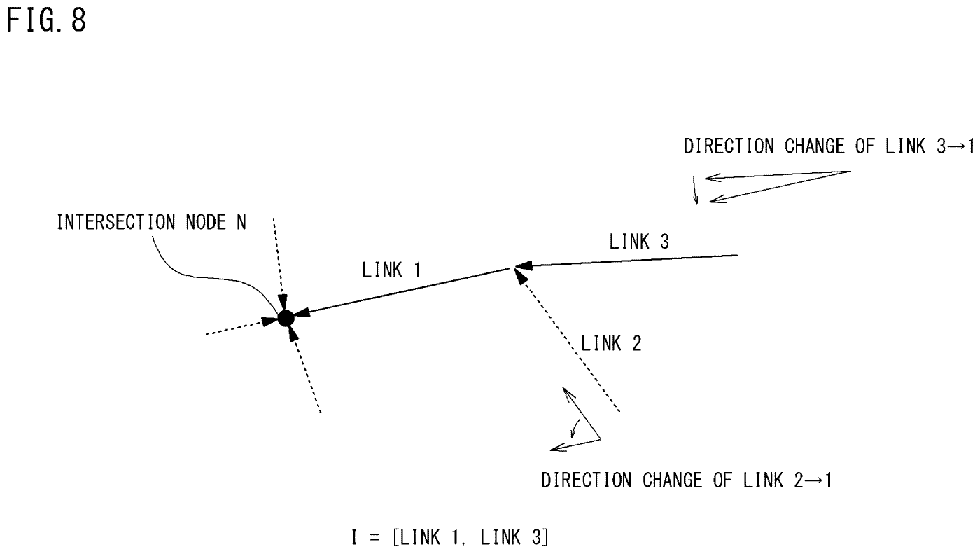

The inflow road detection (step S2) is a process of, for each intersection node extracted by the intersection detection, extracting one or more links in which a traffic congestion having this intersection node as a downstream end is likely to continue. The inflow road detection will be described in detail later (FIG. 7 and FIG. 8).

The congestion length calculation (step S3) is a process calculating a congestion length in the plurality of links extracted by the inflow road detection, based on the time-series data of the traffic information regarding the plurality of links and corresponding to the designated period.

For example, when the traffic information is the link average speed, the control unit 11 determines one or a plurality of links, whose link average speed is equal to or lower than a predetermined threshold value (e.g., 20 km/h), to be an inflow road under traffic congestion, and regards the length of the inflow road under traffic congestion, as a congestion length.

When the traffic information is the link travel time, the control unit 11 determines one or a plurality of links, whose link travel time is equal to or longer than a predetermined threshold value (e.g., 100 seconds), to be an inflow road under traffic congestion, and regards the length of the inflow road under traffic congestion, as a congestion length.

The one-side congestion detection (step S4) is a process of selecting, as a target intersection that requires adjustment of a traffic signal controller, an intersection that is estimated to have “one-side congestion” with a great difference in congestion length between inflow roads intersecting each other, from among a plurality of intersection nodes.

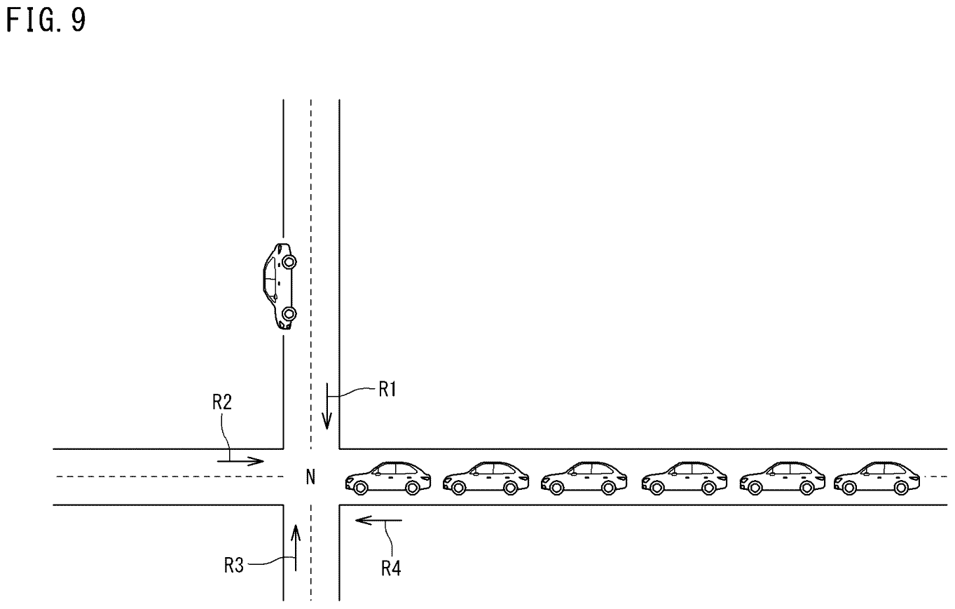

In this case, a pair of inflow roads in opposite directions are highly likely to be in the same phase, and therefore may be treated as a group. An example of the one-side congestion will be described later (FIG. 9).

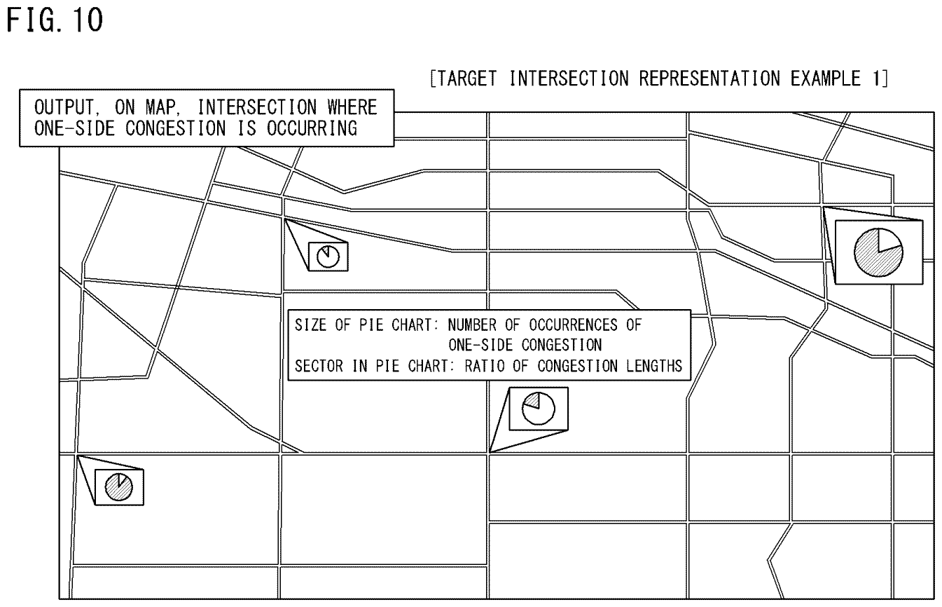

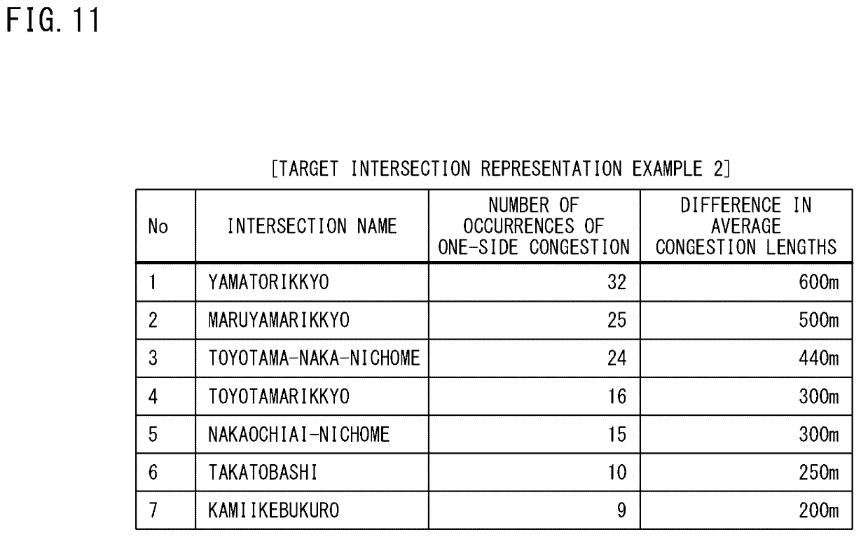

The output of target intersection (step S5) is a process of causing the display unit 15 to display the target intersection selected by the one-side congestion detection. Examples of representation of the target intersection will be described later (FIG. 10 and FIG. 11).

[Intersection Detection]

FIG. 5 is a flowchart showing an example of intersection detection (step S1 in FIG. 4) performed by the control unit 11 of the information processing apparatus 1.

As shown in FIG. 5, the control unit 11 of the information processing apparatus 1 firstly determines whether or not there is a node shared by terminal points of a plurality of links, i.e., a node in which a plurality of links terminate, among the plurality of nodes included in the designated area (step ST11).

When the determination result in step ST11 is negative, the control unit 11 determines that this node is not an intersection (step ST12). The reason is that a node into which only one link flows can be regarded as an intermediate point that is set in the middle of one road.

When the determination result in step ST11 is positive, the control unit 11 determines whether or not the number of the links that share the node is 2 (step ST13).

When the determination result in step ST12 is negative, the control unit 11 determines that the node is an intersection (step ST15). The reason is that a node n1 at which three or more links terminate can be regarded as an intersection, as shown by an example of an intersection in FIG. 6A, for example.

When the determination result in step ST12 is positive, the control unit 11 further determines whether or not an angle formed between the two links is equal to or greater than a predetermined threshold value A (e.g., 30 degrees) (step ST14).

When the determination result in step ST14 is negative, the control unit 11 determines that the node is not an intersection (step ST12). The reason is that a node n2, at which two inflow roads intersecting each other with an angle smaller than the threshold value A terminate, can be regarded not as an intersection but as a junction, as shown by an example of a junction in FIG. 6B, for example.

When the determination result in step ST14 is positive, the control unit 11 determines that the node is an intersection (step ST15).

[Inflow Road Detection]

FIG. 7 is a flowchart showing an example of inflow road detection (step S2 in FIG. 4) performed by the control unit 11 of the information processing apparatus 1.

In FIG. 7, “I” is a variable indicating a most upstream link of a traffic congestion starting from an intersection node, “J” is a threshold value indicating an estimated maximum congestion length (e.g., 2000 m), and L(I) is a variable indicating a distance from the intersection to a start end of the most upstream link.

The control unit 11 of the information processing apparatus 1 subjects all the intersection nodes detected by the intersection detection to the process shown in FIG. 7.

As shown in FIG. 7, the control unit 11 of the information processing apparatus 1 firstly adds, to the variable I, an inflow link having an intersection node as its terminal end, and regards the added inflow link as a most upstream link. Next, the control unit 11 determines whether or not L(I)>J is satisfied (step ST22).

When the determination result in step ST22 is positive, the control unit 11 ends the process.

When the determination result in step ST22 is negative, the control unit 11 adds, to the variable I, a link, among links that flow in the start end of the current most-upstream link, whose direction change with respect to the current most-upstream link is smallest, so that the added link becomes a new most-upstream link. Thus, the process is returned to the step before ST22.

FIG. 8 illustrates an example of the most upstream link detected by the inflow road detection.

In FIG. 8, “N” is one node among the plurality of intersection nodes extracted by the intersection detection. A link 1 is a link whose terminal end matches the intersection node N, and the length of the link 1 is equal to or shorter than the threshold value J. A link 2 and a link 3 are links whose terminal ends match a start end of the link 1.

In this case, the link 1 is the most upstream link according to step ST21 in FIG. 7, but the determination result in step ST22 is negative because the link 1 is equal to or shorter than the threshold value J.

Of the link 2 and the link 3, the link 3 has the smallest direction change with respect to the link 1. Therefore, according to step ST23 in FIG. 7, the link 3 is added as a new most-upstream link.

[One-side congestion detection]

FIG. 9 illustrates an example of one-side congestion detected by the control unit 11. As shown in FIG. 9, it is assumed that, at an intersection N of crossroads where four inflow roads R1 to R4 flow in, a traffic congestion is occurring on one inflow road R4. In this case, since only the inflow road R4 is congested at the intersection N, the control unit 11 of the information processing apparatus 1 determines that the intersection N is an intersection where one-side congestion is occurring.

In the case of the intersection N of crossroads, the control unit 11 determines that the intersection node N where any of events 1) to 6) as follows is occurring is an intersection having one-side congestion, for example.
1) Traffic congestion on only inflow road R1
2) Traffic congestion on only inflow road R2
3) Traffic congestion on only inflow road R3
4) Traffic congestion on only inflow road R4
5) Traffic congestion on inflow roads R1, R3 where signal lights are in the same phase
6) Traffic congestion on inflow roads R2, R4 where signal lights are in the same phase

The reason is as follows. That is, in the case of the intersection N at which the one-side congestion is occurring, if adjustment, such as extending the green interval in the inflow direction where the congestion is occurring, is performed, the congestion starting from the intersection N is highly likely to be cleared up.

In the case where traffic congestions are occurring on two inflow roads intersecting each other, the control unit 11 determines that the intersection N where any of events a) to d) as follows is occurring is not an intersection where one-side congestion is occurring.
a) Traffic congestions on inflow road R1 and inflow road R2
b) Traffic congestions on inflow road R2 and inflow road R3
c) Traffic congestions on inflow road R3 and inflow road R4
d) Traffic congestions on inflow road R4 and inflow road R1

The reason is as follows. That is, in the case of the intersection N where traffic congestions are occurring on two inflow roads intersecting each other, even when the green interval or the like of the traffic signal controller at the intersection N is adjusted, this adjustment does not contribute to clearing-up of the traffic congestions on the inflow roads.

### Target Intersection Representation Example 1

FIG. 10 illustrates an example of representation of target intersections.

In the example of representation shown in FIG. 10, intersections at which one-side congestions have been detected are displayed, on a map, as intersections (target intersections) that require adjustment of traffic signal controllers.

Specifically, the control unit 11 of the information processing apparatus 1 illustrates pie charts in the vicinity of the target intersections at which the one-side congestions have been detected, thereby indicating which intersections on the map are the target intersections.

As shown in FIG. 10, with the size of the pie chart, the control unit 11 indicates the number of occurrences of one-side congestion during the designated period. In addition, with a sector in the pie chart, the control unit 11 indicates a ratio of congestion lengths of inflow roads intersecting each other.

The number of occurrences of one-side congestion and the ratio of congestion lengths may be displayed by a graph of another shape, such as a bar graph, instead of the pie chart.

In the information processing apparatus 1 of the present embodiment, the control unit 11, being triggered by a predetermined operation input to the map shown in FIG. 10, causes the display unit 15 to display an analysis result of time-series transition of traffic indices such as congestion lengths of inflow roads of an intersection designated by the operation input. An example of representation of the analysis result will be described later.

### Target Intersection Representation Example 2

FIG. 11 illustrates another example of representation of target intersections.

In the example of representation shown in FIG. 11, the names of intersections at which one-side congestions have been detected are displayed in a table format, as intersections (target intersections) that require adjustment of traffic signal controllers.

Specifically, the control unit 11 of the information processing apparatus 1 causes the display unit 15 to output a table including “intersection names” of target intersections at which one-side congestions have been detected.

The table shown in FIG. 11 includes, in addition to the column of “intersection name”, columns of “number of occurrences of one-side congestion” and “difference in average congestion lengths”.

When there are a plurality of target intersections at which one-side congestions have been detected, the control unit 11 enters an intersection having a greater value of the number of occurrences of one-side congestion, at a higher position in the table. In addition, under the column of “difference in average congestion lengths”, the control unit 11 enters a value of a difference in average congestion lengths of the intersection corresponding to each intersection name.

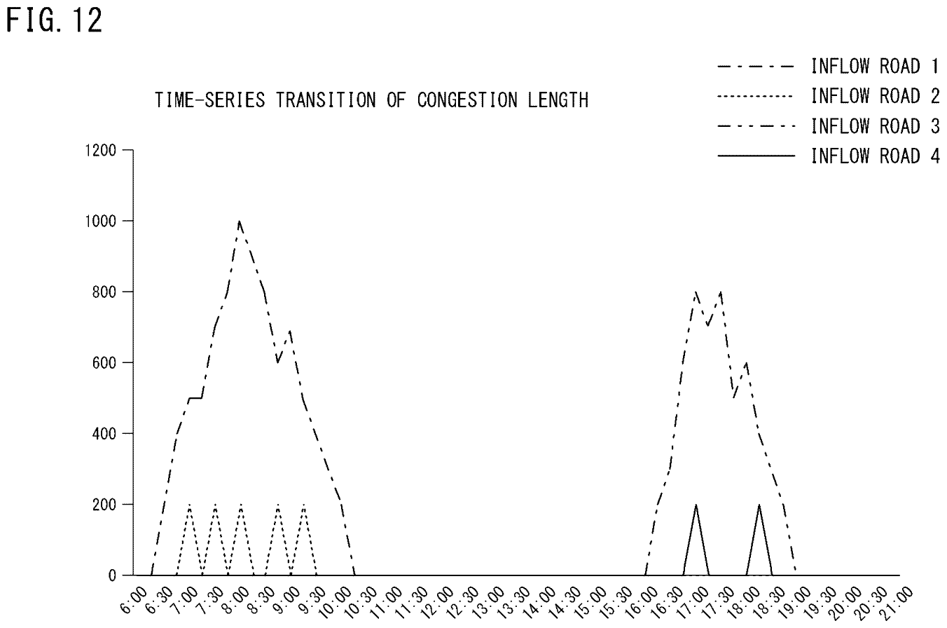

In the information processing apparatus 1 of the present embodiment, the control unit 11, being triggered by a predetermined operation input to the table shown in FIG. 11, causes the display unit 15 to display an analysis result of time-series transition of traffic indices such as congestion lengths of inflow roads of an intersection designated by the operation input. An example of representation of the analysis result will be described later.

[Analysis result display example 1] FIG. 12 illustrates an example of representation of time-series transitions of congestion lengths.

The example of representation shown in FIG. 12 is displayed on the display unit 15 with either of operation inputs a1, a2 as follows being a trigger.

Operation input a1: A mouse click or a touch operation to a pie chart or an intersection included in the map shown in FIG. 10

Operation input a2: A mouse click or a touch operation to an intersection name included in the table shown in FIG. 11

In the example of representation shown in FIG. 12, time-series transitions of congestion lengths regarding inflow roads of an intersection designated by an operation input performed by the user, are displayed as “line graphs”.

In the example of representation shown in FIG. 12, the horizontal axis of the coordinate system indicates time, and the vertical axis of the coordinate system indicates the inflow road congestion length. A plurality of line graphs indicate the congestion lengths, for each time, of the inflow roads 1 to 4 of the designated intersection. Therefore, the user can consider in which time section the target intersection should be subjected to adjustment of a constant, based on the positions and the shapes of the line graphs.

### Analysis Result Representation Example 2

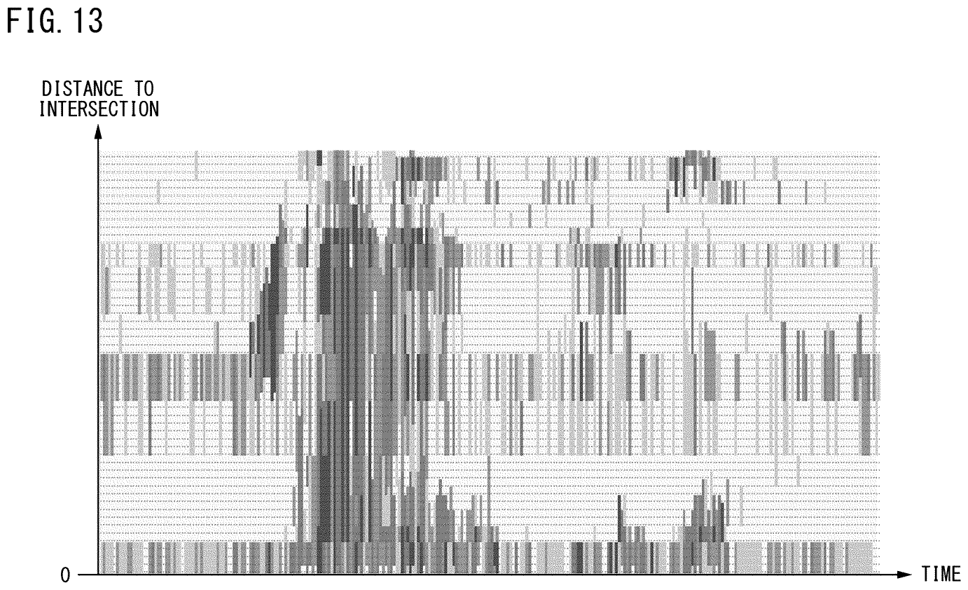

FIG. 13 illustrates an example of representation of time-series transitions of inflow road speeds.

The example of representation shown in FIG. 13 is displayed on the display unit 15 with an operation input b as follows being a trigger.

Operation input b: A mouse click or a touch operation to an inflow road of an intersection, at which a pie chart is displayed, included in the map shown in FIG. 10.

In the example of representation shown in FIG. 12, time-series transition of an average speed (inflow road speed) of vehicles on an inflow road designated by an operation input performed by the user, is displayed by a “density distribution chart”.

In the density distribution chart shown in FIG. 12, the horizontal axis of the coordinate system indicates time, and the vertical axis of the coordinate system indicates the distance to the intersection from the designated inflow road. In the density distribution chart, the higher the density is, the lower the speed is. Therefore, the user can consider in which time section the target intersection should be subjected to adjustment of a constant, based on density variation in the density distribution chart.

### Effect of Information Processing Apparatus

As described above, according to the information processing apparatus 1 of the present embodiment, the control unit 11 extracts, from the nodes included in the map data 16, intersection nodes corresponding to intersections included in a geographical range designated by the user (designated area), and acquires time-series data of traffic information corresponding to a temporal range designated by the user (designated period) from the database 17 of the time-series data of the traffic information.

Moreover, based on the acquired time-series data of the traffic information, the control unit 11 selects a target intersection that requires adjustment of a constant of a traffic signal controller from among the extracted intersection nodes, and causes the display unit to output the selected target intersection (see FIG. 10 and FIG. 11).

Therefore, the user can perceive in advance which intersection is a target intersection, based on the target intersection displayed on the display unit 15. Therefore, the user can easily judge presence/absence of a target intersection in the designated area.

### First Modification

In the above embodiment, a designated placement number that is a placement number designated by the user may be included in the node extraction condition (extraction condition 1).

In this case, the control unit 11 may regard, as an intersection node to be extracted, a node at which the number of placed signal light marks, in the map data 16, is equal to or less than the designated placement number, among the nodes included in the map data 16.

Thus, intersection nodes to be extracted are narrowed to nodes at which the number of placed signal light marks, in the map data 16, is equal to or less than the designated placement number.

Therefore, only a target intersection of the scale desired by the user (e.g., an intersection estimated to adopt the independent control scheme) can be outputted to the display unit.

### Second Modification

In the above embodiment, a designated class indicating a road scale designated by the user may be included in the node extraction condition (extraction condition 1).

In this case, the control unit 11 may regard, as an intersection node to be extracted, a node connected to a link whose road class in the map data 16 is the designated class, among the nodes included in the map data 16.

Thus, intersection nodes to be extracted are narrowed to nodes connected to links whose road classes in the map data 16 are the designated class.

Therefore, only a target intersection of the scale desired by the user (e.g., an intersection estimated to adopt the independent control scheme) can be outputted to the display unit.

### Third Modification

In the above embodiment, input data that the user inputs to the information processing apparatus 1 through the operation unit 14 may be limited to the node extraction condition (extraction condition 1), i.e., the time-series data extraction condition (extraction condition 2) may not be inputted by the user.

In this case, the control unit 11 may acquire, from the database 17, time-series data of traffic information corresponding to a predetermined period that is set in advance, for example.

The predetermined period that is set in advance is conceivable to be the last 5 minutes, for example. The predetermined period may be the last 1 hour, the last 24 hours, the last 30 days, the last 365 days, or the like, or may be all the time-series data being accumulated in the database 17.

### Fourth Modification

In the above embodiment, as an operation input to be received by the operation unit 14, an event type that suggests a disorder in setting a constant of a traffic signal controller may be included.

Examples of the event type include: one-side congestion described above; downstream congestion; and stop through several changes of signal light. The reason is as follows. That is, each of one-side congestion, downstream congestion, and stop through several changes of signal light is an event that suggests a disorder, in setting the number of seconds of a green interval, of a traffic signal controller. Therefore, presence/absence of such an event is appropriate as a criterion for selecting a target intersection.

The “stop through several changes of signal light” refers to an event in which a vehicle cannot go through an intersection even after two or more turns of red light, among stop of vehicles due to waiting for signal light to change.

When the event type described above is inputted, the control unit 11 may use presence/absence of the inputted event as a criterion for selecting a target intersection. This allows the control unit 11 to select a target intersection with presence/absence of an event desired by the user being a selection criterion.

The embodiments disclosed above are merely illustrative in all aspects and are not restrictive. The technical scope of the present disclosure is not limited to the above-described embodiments, and all changes which come within the range of equivalency of the configurations recited in the claims are therefore intended to be included therein.

### REFERENCE SIGNS LIST

1 information processing apparatus
10 casing
11 control unit (information processing unit)
12 storage unit
13 communication unit
14 operation unit
15 display unit
16 map data
17 database
20 input screen
20A input box
20B GUI screen

1. An information processing apparatus comprising:
an operation unit configured to receive an operation input regarding a first extraction condition; and
a control unit configured to perform predetermined information processing, based on the first extraction condition, wherein
the information processing includes
a process of extracting one or a plurality of intersection nodes corresponding to intersections that conform to the first extraction condition, from among nodes included in map data,
a process of acquiring time-series data of traffic information from a database in which the time-series data of the traffic information is accumulated, and
a process of selecting, from among the one or the plurality of intersection nodes having been extracted, a target intersection that requires adjustment of a constant of a traffic signal controller, based on the acquired time-series data of the traffic information, and outputting the selected target intersection to a display unit.

2. The information processing apparatus according to claim 1, wherein
the first extraction condition includes a designated area that is a geographical range designated by a user, and
the control unit extracts nodes included in the designated area, in the process of extracting the intersection nodes.

3. The information processing apparatus according to claim 1, wherein
the first extraction condition includes a designated placement number that is a placement number designated by the user, and
the control unit extracts nodes at which the number of placed signal light marks in the map data is equal to or less than the designated placement number, in the process of extracting the intersection nodes.

4. The information processing apparatus according to claim 1, wherein
the first extraction condition includes a designated class that indicates a road scale designated by the user, and
the control unit extracts nodes connected to links whose road classes in the map data are equal to the designated class, in the process of extracting the intersection nodes.

5. The information processing apparatus according to claim 1, wherein
the operation unit further receives an operation input regarding a second extraction condition, and
the process of acquiring the time-series data of the traffic information is a process of acquiring time-series data of traffic information that conforms to the second extraction condition.

6. The information processing apparatus according to claim 5, wherein
the second extraction condition includes a designated period that is a temporal range designated by the user, and
the control unit acquires, from the database, the time-series data of the traffic information corresponding to the designated period.

7. The information processing apparatus according to claim 1, wherein
when selecting the target intersection with presence/absence of one-side congestion being a selection criterion, the control unit outputs, to the display unit, the number of occurrences of one-side congestion at the selected target intersection.

8. The information processing apparatus according to claim 1, wherein
the operation unit further receives an event type that suggests a disorder in setting a constant of the traffic signal controller, and
the control unit uses presence/absence of the event having been inputted, as a selection criterion for the target intersection.

9. The information processing apparatus according to claim 8, wherein
the event type includes at least one of one-side congestion, downstream congestion, and stop through several changes of signal light.

10. The information processing apparatus according to claim 1, wherein
the control unit
is capable of analyzing a time-series transition of a predetermined traffic index on an inflow road of the intersection node, and
outputs, to the display unit, an analysis result of the time-series transition, with respect to an inflow road of an intersection designated by an operation input to a screen of the display unit.

11. The information processing apparatus according to claim 1, wherein
the time-series data of the traffic information is generated based on probe information including position and time of a vehicle.

12. An information processing method performed by an information processing apparatus including an operation unit configured to receive an operation input regarding a first extraction condition, and a control unit configured to perform predetermined information processing, based on the first extraction condition,
the method comprising the steps of:
extracting one or a plurality of intersection nodes corresponding to intersections that conform to the first extraction condition, from among nodes included in map data,
acquiring time-series data of traffic information from a database in which the time-series data of the traffic information is accumulated, and
selecting, from among the one or the plurality of intersection nodes having been extracted, a target intersection that requires adjustment of a constant of a traffic signal controller, based on the acquired time-series data of the traffic information, and outputting the selected target intersection to a display unit.

13. A non-transitory computer readable storage medium storing a computer program configured to cause a computer to function as an information processing apparatus including an operation unit configured to receive an operation input regarding a first extraction condition, and a control unit configured to perform predetermined information processing, based on the first extraction condition,
the information processing including:
a process of extracting one or a plurality of intersection nodes corresponding to intersections that conform to the first extraction condition, from among nodes included in map data,
a process of acquiring time-series data of traffic information from a database in which the time-series data of the traffic information is accumulated, and
a process of selecting, from among the one or the plurality of intersection nodes having been extracted, a target intersection that requires adjustment of a constant of a traffic signal controller, based on the acquired time-series data of the traffic information, and outputting the selected target intersection to a display unit.
